(19) United States
(12) Patent Application Publication
(10) Pub. No.: US 2026/0099536 A1
(43) Pub. Date: Apr. 9, 2026

(54) METHOD AND SYSTEM FOR GENERATING TEXT DATA

(71) Applicant: ThinkAnalytics Ltd., Glasgow (GB)

(72) Inventors: Christopher McGuire, Glasgow (GB); Peter Docherty, Glasgow (GB)

(73) Assignee: ThinkAnalytics Ltd., Glasgow, Lanarkshire (GB)

(21) Appl. No.: 18/906,673

(22) Filed: Oct. 4, 2024

(51) Int. Cl. G06F 16/383; G06F 16/31

(52) U.S. Cl. CPC G06F 16/383; G06F 16/31

(57) ABSTRACT

A computer-implemented method for generating text data comprising a descriptor for a group of content of items, the method comprising: obtaining content metadata associated with a group of content items; generating a descriptor for the group of content items based on at least the content metadata associated with the group; at least one of displaying and storing the generated descriptor.

### BACKGROUND

The present disclosure relates to a system and method for use in content recommendation systems. In examples, the system and method includes generating descriptive text for a group of content items.

Developments in technology mean that users are able to access content via a wide array of different mechanisms, and via a wide array of different sources. For example, television channels, radio stations, video-on-demand and other streaming services, social media and other internet content sources provide a vast array of content available to a user.

By providing a large volume of content, content distribution platforms can cater to a large range of different user preferences and provide content previously unseen to a user to hold the user's interest. However, the large volumes of available content gives rise to challenges in making it easy for users to identify, navigate and select content.

As part of a content selection interface, content items are typically provided together with descriptive metadata. For example, descriptors for groups of items may be provided.

### SUMMARY OF THE INVENTION

According to a first aspect, there is provided a computer-implemented method for generating text data comprising a descriptor for a group of content of items, the method comprising: obtaining content metadata associated with a group of content items; generating a descriptor for the group of content items based on at least the content metadata associated with the group. The method may further comprise displaying a content selection interface representing a plurality of content items, wherein the content selection interface is operable by a user to select one of the plurality of content items. The method may further comprise displaying the generated descriptor as part of the content selection interface.

The method may further comprise obtaining user data for a user; generating the descriptor based on the obtained user data to provide a personalised descriptor for the group of content items.

The method may comprise performing a comparison between the content metadata and the user data, wherein the comparison may include determining the content metadata associated with the content items that is most relevant to the user and selecting and/or filtering the content metadata based on the comparison.

The method may comprise filtering the content metadata, a subset of the content metadata representing a customized and/or a personalized set of the content metadata for the user is generated.

The method may comprise obtaining user data for a user and content metadata for a content item and generating a prompt for a descriptive text generator based on the obtained user data and content metadata.

The method may further comprise providing the prompt to the descriptive text generator and receiving generated descriptor from the text generator.

The method may further comprise determining an overlap and/or determining common metadata between the content metadata and the user data and generating the descriptor based on the overlap and/or common metadata.

The method may further comprise representing the user data as a first feature vector or other mathematical representation and the content metadata as a second feature vector, and wherein the descriptor is based on a determination of a dot product or other measure of overlap between the first feature vector or other mathematical representation and second feature vector or other mathematical representation.

The method may further comprise obtaining metadata associated with each content item in a group of content items and combining the metadata into group metadata for the group.

The content data may be represented as a feature vector or other data structure and wherein the method comprises generating a prompt or other input for a model based on said feature vector or other data structure. Generating the prompt may comprise extracting one or more features or keywords from the content metadata, for example, from said feature vector.

The plurality of content items may be are grouped into two or more groups, each group represented in the content selection interface as part of or associated with an interactive graphical element and wherein the method further comprises generating a descriptor for each group using content metadata for each content item of the group and displaying the interactive graphical element together with the descriptor.

Generating the descriptive text may comprise packaging at least part of the content metadata and/or one or more selected parameters into one or more requests and sending said one or more requests to a further processing resource. The further processing resource may host the generative text model. The further processing resource may be configured to receive the one or more requests, generate the descriptive text based on the one or more requests and send a response signal including the generated descriptive text. The request may be packaged in the form of an API call.

The method may comprise performing a validation process on the generated text and discarding and/or modifying and/or regenerating the descriptive text based on the outcome of the validation process. The validation process may comprise evaluating a semantic similarity or other similarity metric between at least the content metadata and the generated text. The validation process may comprise constructing a vector or other representation of the generated descriptive text and comparing said vector or other representation to a corresponding vector or representation of the user data.

The content selection interface may comprise a plurality of scrollable carousels and the method comprises providing respective at least said group of content to the user in a scrollable carousel of the user interface together with the generated descriptor.

Generating the descriptor may further comprise applying a pre-determined generative model or other machine learning or artificial intelligence model to at least the content metadata. Generating the descriptive persona text may comprise applying a model, for example, a machine learning or other generative artificial intelligence model to at least part of the user data and/or associated content metadata. The model may be configured to output text. The model may comprise a large language model and/or a natural language processing model and/or a machine learning and/or artificial intelligence model. The model may comprise a trained machine learning and/or artificial intelligence and/or natural language processing model previously trained and/or refined on a volume of text data.

The method may further comprise providing at least part of the user data as input to a pre-determined machine learning model, for example a generative text or language model. The model may comprises a Markov based model, a Recurrent Neural Network, a Long Short Term Memory or large language model, for example, a transformer-based language model. The method may further comprise selecting one or more parameters for the model, wherein the one or more parameters are selected based on a current system performance parameter. The one or more parameters may comprise language, a length and/or size of the text data to be generated.

Generating the descriptor may be performed as part of a content recommendation process.

The method may comprise obtaining a group of candidate items and/or their identifiers, optionally based on user data, as part of a content recommendation process and retrieving metadata for said group of candidate items, as part of the content recommendation process.

The content metadata may correspond to values for one or more properties or parameters or characteristics, such as programme title, time, duration, content type, programme categorisation, actor names, genre, release data, episode number, series number, style, mood, language and theme. The properties or parameters or characteristic may include one or more of the following: Audience; Award; Category; Character; Character Type; Concept Source; Director; Format; Franchise; Host; Milieu; Mood; Producer; Person; Subcategory; Scenario; Setting; Sports Competition; Studio; Style; Subject; Team; Theme; Time Period; Writer. The content metadata may comprise a weighting for the one or more properties or parameters or characteristics.

The method may further comprise displaying and/or storing the generated text. The method may further comprise displaying the generated text on a display, optionally on a display of a user device. The method may further comprise storing the generated text as data on a storage device.

Generating the descriptive text may comprise using a text generator. The user data and/or associated metadata may comprise data representing user preferences based on user engagement with a plurality of content items, for example, one or more content libraries. The user data and/or associated metadata may comprise or form a user profile for a user determined based on previous user engagement with a plurality of content libraries. The user data and/or associated metadata may comprise data produced by a metadata enriching process.

According to a second aspect, there is provided a system comprising processing circuitry configured to generate text data comprising a descriptor for a group of content of items, wherein the processing circuitry is configured to: obtain content metadata associated with a group of content items; generate a descriptor for the group of content items based on at least the content metadata associated with the group; at least one of display and store the generated descriptor.

The system may comprise a display for displaying a content selection interface representing a plurality of content items, wherein the content selection interface is operable by a user to select one of the plurality of content items and wherein the display is configured to display the generated descriptor.

The system may comprise a storage resource for storing the generated descriptor.

According to a third aspect, there is provided a non-transitory computer-readable medium that comprises computer-readable instructions that are executable to: obtain content metadata associated with a group of content items; generate a descriptor for the group of content items based on at least the content metadata associated with the group; at least one of transmit the generated descriptor to a display for display or store the generated descriptor.

Features in one aspect may be provided as features of another aspect in any appropriate combination. For example, method features may be provided as system features, and vice versa.

### BRIEF DESCRIPTION OF THE DRAWINGS

Various aspects of the invention will now be described by way of example only, and with reference to the accompanying drawings, of which:

FIG. 1 is a schematic diagram of a digital content recommendation system;

FIG. 2 is representation of certain database learning tables used by the system of FIG. 1;

FIG. 3 is a schematic diagram of a file structure;

FIG. 4 is a schematic diagram of a content selection interface;

FIG. 5 is a schematic diagram of a carousel of a content selection interface;

FIG. 6 is an overview of a method of a workflow for obtaining and displaying a descriptor for a group of content items;

FIG. 7 is an overview of a method of generating a descriptor for a group of items;

FIG. 8 is an overview of a method of a workflow for obtaining and displaying a descriptor for a group of content items;

FIG. 9 is an overview of a method of generating a descriptor for a group of items;

FIG. 10 is a simplified schematic of an alternative system arrangement to that of FIG. 1, and

FIG. 11 is a schematic of a system for configuring a content selection interface;

### DETAILED DESCRIPTION

The embodiments described below relate to methods of generating descriptive text data, for example, text description for items of content, in particular, for groups of content items recommended by a content recommendation system. The descriptive text data may include descriptors that provide a description of the group of content items. A descriptor can be understood as a word or phrase uses to describe or identify the group of content. As described in the following, in some embodiments, the descriptor is generated based on user data to provide a customized description for the group. A descriptor may be understood as a concise phrase used to describe or identify a group of content. A descriptor may be understood as descriptive text having a length under a pre-determined size, for example, fewer than 10 words, optionally, fewer than 5 words.

The following embodiments relate to use of user data, for example, in the form of a user profile that is collected and stored based on user activity. It will be understood that a user profile comprises metadata items that are obtained based on user activity. Each metadata item relates to a metadata category and associated weights. The left hand side depicts metadata items in terms of metadata categories. In practical examples, the number of metadata items collected in a user profile may be large.

In the context of content recommendation systems, it is to be understood that there may be a very large number of users posing significant technical challenges for analyzing and interpreting user activity. In addition, there is a need to provide descriptions of groups of content items.

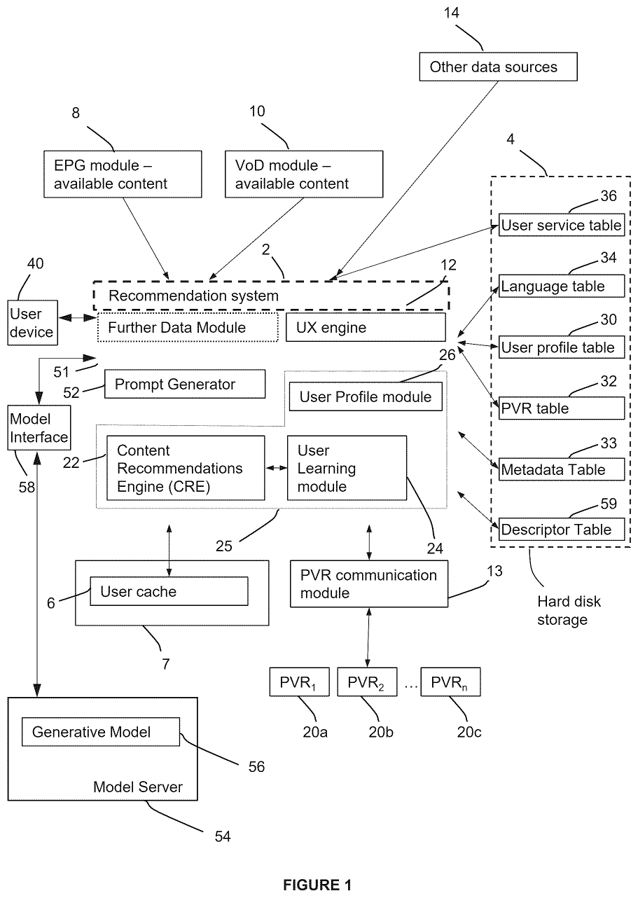

FIG. 1 shows a schematic diagram of content recommendation system according to an embodiment, which is operable to generate content recommendations for users based on first party data in the form of, for example, user actions performed in relation to their selection, viewing and other actions in relation to TV content provided by a TV distribution system, and/or in relation to other content. The content recommendation system is configured to perform one or more content recommendation methods. As part of the content recommendation system, the system has additional features and modules for providing an additional level of customization. In particular, a further data module is provided as described in the following.

The system in the embodiment of FIG. 1 comprises a content recommendation system 2 that comprises a content recommendation engine (CRE) or module 22 and linked to a first storage resource in the form of a hard disk storage device 4, which is used to store various user data. The recommendation system 2 is also communicatively linked to a second storage resource in the form of a local storage device that includes at least one cache, for example a user cache 6. In the embodiment of FIG. 1 the local storage device is in the form of RAM 7 but any suitable storage device may be used in alternative embodiments. The user cache 6 may be used for temporary storage of user data obtained from the hard disk storage device 4 during a user session.

The content recommendation engine (CRE) 22 can apply a set of processes, to determine, in real time, content recommendations for a user 205 based on user data and available content.

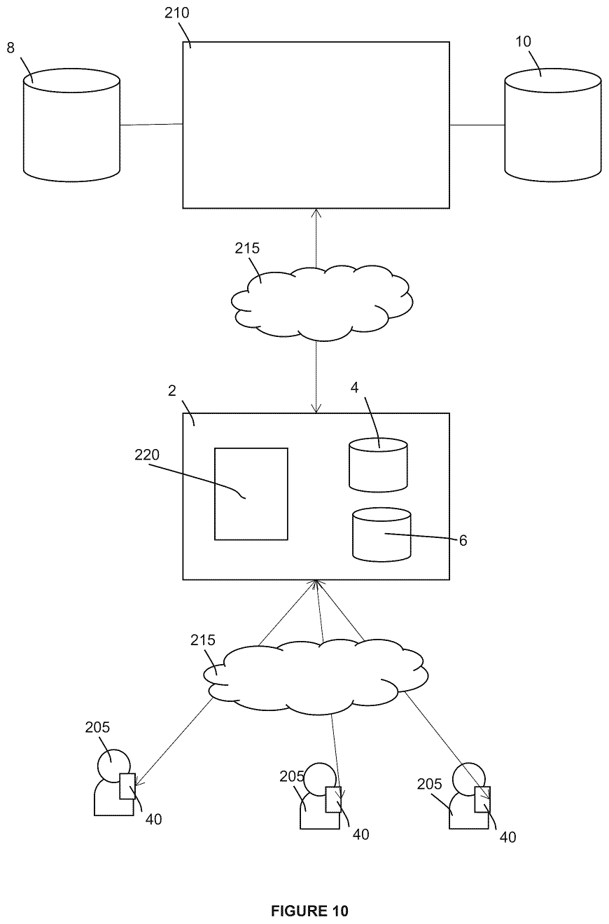

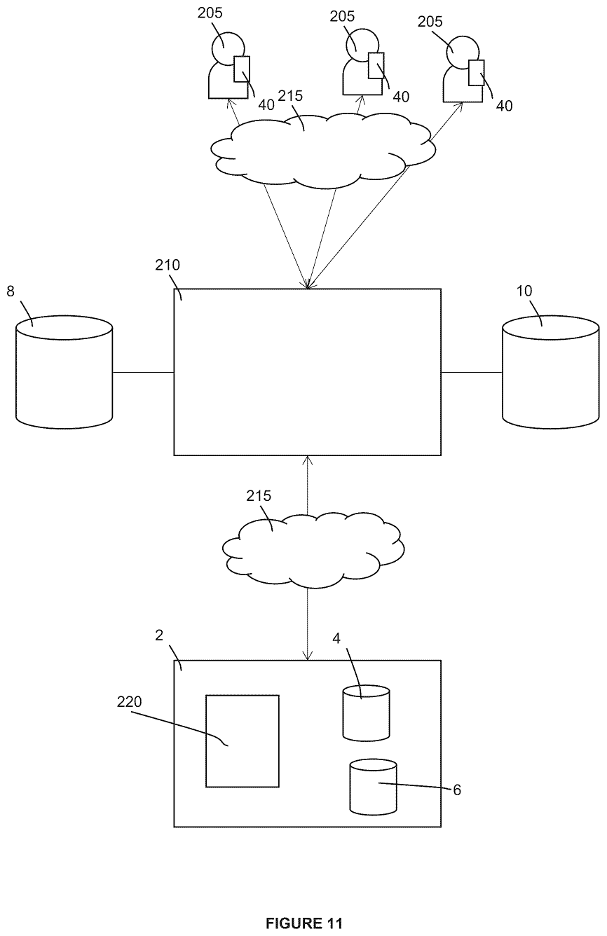

FIG. 1 shows a schematic diagram of a system 1 that comprises a user experience (UX) engine 12 for configuring user content selection interfaces that allow users 205 (see FIGS. 10 and 11) to navigate and select content from a content service provider (210, also shown in FIGS. 10 and 11). In particular, the user experience (UX) engine 12 can be used to provide customised user content selection interfaces that are customised or otherwise specifically configured to a specific user 205 or group of users 205. The customization can comprise, for example, customizing the order in which groups of content is presented to a user 205 or groups of users 205 so that groups of content more likely to be of interest to the user 205 are presented earlier, or in preference to groups of content that are less likely to be of interest to that user 205.

In the example of FIG. 1, the user experience (UX) engine 12 is provided as part of a more general recommendation system 2 that comprises a content recommendation engine (CRE) 22 that can apply a set of processes to determine, in real time, content recommendations for a user 205 based on user data and available content. This arrangement can be beneficial as there may be some cross-over in the data utilised such that the UX engine 12 can in some examples share or otherwise leverage data used by the CRE 22, which can minimise data storage and other services required to operate both systems. However, the disclosure is not limited to this arrangement and in other examples the UX engine 12 can be provided as a dedicated stand-alone system or as part of a content provider's user interface system or in another suitable component of a content provision system or associated support system.

The UX engine 12 is configured to take into account previous interactions that the user 205 has had with user content selection interfaces. These could include interactions the user 205 has had with the user content selection interface that the system 1 is currently looking to configure and/or with other user content selection interfaces. Beneficially, such user interactions may comprise first party data in the form of, for example, user actions performed in relation to their selection, viewing and other actions in relation to content such as but not limited to TV content provided by a TV distribution system or other types of content.

FIG. 1 depicts a further data module 51. The further data module 51 has a prompt generator 52. The further data module may be configured to generate further data, in particular, descriptive text data based on user data and/or content metadata. The further data module 51 may be referred to as a persona text module. The further data module may be configure to generate descriptive text for one or more segments of users. While a generative model is described, other machine learning derived or artificial intelligence based models may be used. In some embodiments, the generative model is a large language model (LLM).

The further data module 51 is configured to communicate with one or more data sources. In the system of FIG. 1, the further data module 51 is configured to communicate with one or more remote servers 54 to access a generative model 56. It will be understood that communication between the further data module 51 and the generative model 56 on remote server 54 is via a communication interface, represented by model interface 58.

In the following embodiments, the further data module 51 is configured to generate or obtain a descriptive text for identified groups or segments of users based on user data collected for the users. As described elsewhere, the EPG module 8 and the VoD module 10 obtain information concerning available content from the content sources, for example, a TV service operator or other content service operator. As part of the descriptive text generation, user data, for example, in the form of a user profile is obtained. In embodiments, the user profile is obtained by the further data module 51 from user profile module or user profile table 30.

In the present embodiment, the further data module 51 is depicted as a separate module to the recommendation system 25, however, it will be understood that the further metadata module may be provide as part of the recommendation system or as part of the UX engine. In particular, in some embodiment, the descriptive text may be generated during a recommendation procedure executed by the CRE 22. In some embodiments, the descriptive text may be generated during a content selection process controlled by the UX engine. In embodiments, the generation of the descriptive text is performed by an API call separate to a content recommendation process.

In the present embodiment, the model server 54 hosts a generative model, for example, a machine learning or artificial intelligence model for generating textual information. In the present embodiment, the machine learning model is a generative language model 56. In some embodiments the machine learning model is a generative AI large language model. The machine learning model may be a Markov process, Recurrent Neural Network, Long Short Term Memory or large language model, for example, a transformer-based language model. The machine learning model may be a large language model, for example, a transformer-based language model. Access to the generative model 56 is provided by the model interface 58. The model interface 58 may comprise one or more APIs (Application Programming Interfaces). The model interface 58 is configured to transmit language prompts and requested model parameters packaged as one or more requests to the model server 54. The prompt is provided to the model 56 and the model is configured to output text, in the following embodiments, a descriptor for a group of content items. The model interface 58 communicates the results to further data module 51.

The content recommendation engine (CRE) 22 in this example is provided as part of an affinity profile generation system, which is operable to generate affinity profiles for users 205 based on first party data in the form of, for example, user actions performed in relation to their selection, viewing and other actions in relation to TV content provided by a TV distribution system, and/or in relation to other content. The recommendation system 2 in the embodiment of FIG. 1 is also able to provide content recommendations to users as well as generating affinity profiles. Content recommendations may be provided in real time or near real time for many thousands, tens of thousands or even hundreds of thousands or more users, for example using techniques as described in UK Patent No. GB 2574581 or U.S. Pat. No. 11,343,573, the content of each of which is incorporated in full herein by reference. However, as noted above, this is an optional arrangement, and the UX engine 12 need not be provided as part of such a recommendation system 2 and can be provided as a stand-alone system or as part of a system with other functionality.

Some example modes of operation are described below in relation to PVRs associated with users, but content may be provided or accessible via any suitable devices, for example set-top boxes, smartphones, PCs or tablets or any other suitable content delivery mechanism.

As discussed further below, the recommendation system is able to communicate, either directly or indirectly, and either via wired or wireless connection, with very large numbers of users or user devices and to provide recommendations for or derived from such users or user devices. Other than some PVRs which are shown schematically in FIG. 1, only a single user device 40 is shown in FIG. 1 for clarity.

The recommendation system 2 is also linked to sources of information concerning available content, in this case an EPG module 8 and a Video-on-Demand (VOD) module which provide information concerning content available to a user via an EPG (for example, scheduled TV programmes on a set of channels) and via a VoD service. In alternative embodiments, a variety of other sources of content may be available as well as, or in addition to, EPG and VoD content, for example internet content and/or any suitable streamed content via wired or wireless connection. As discussed further below, recommendation system 2 is able to communicate, either directly or indirectly, and either via wired or wireless connection, with very large numbers of users 205 or user devices 40 and to provide recommendations for or derived from such users 205 or their user devices 40. Other than some PVRs which are shown schematically in FIG. 1, only a few user devices 40 are shown in FIG. 1 for clarity, but it will be appreciated that more or less user devices 40 could be present. The user devices 40 could include, as examples only, a user's mobile phone, smart TV, tablet computer, laptop, smart watch or other suitable viewing device. Although the user devices 40 could belonging to the user 205, they could also comprise any other device that the user 205 is logged into.

The EPG is provided as an example of a content selection interface that allows users 205 to look for content available from the service provider and to select content, e.g. for download, streaming and/or viewing. However, the present disclosure is not limited to EPGs and could also be applied to other content selection interfaces, e.g. for music provision services, audio book services, film streaming services, creator content, book or article selection interfaces, amongst others. The content may comprise video, audio, text, images, or other data.

In the embodiment of FIG. 1, the UX engine 12, the EPG module 8, the VoD module 10, the recommendation system 2, the User Cache 6, the PVR Communication module 12, the EPG module 8 and the User Learning module 24 are implemented in a server. The server includes communication circuitry that enables communication between the server, or appropriate components of the server, with each of the user devices, and with the content sources, for example, a TV service operator or other content service operator.

It will be understood that requests and results may be communicated between different parts of a network using one or more application programming interfaces (APIs). The API defines the parameters and other data to be included in a request and the form and format of the results from the request. In particular, the content recommendation procedures described in the following are available through one or more APIs.

Any other suitable implementation of the EPG module 8, the VoD module 10, the recommendation system 2, the CRE 22, the user cache 6, the PVR communication module 12, the EPG module 8 and the user learning module 24 may be provided in alternative embodiments, for example they may be implemented in any software, hardware or any suitable combination of software and hardware. Furthermore, in alternative embodiments, any one of the components as described in relation to the embodiment of FIG. 1 or other embodiments may be combined with any other one(s) of the components, or any one of the components may be split into multiple components providing the same or similar functionality.

The EPG module 8 and the VoD module 10 obtain information concerning available content from the content sources, for example, a TV service operator or other content service operator. The content information comprises metadata of content, for example, television programme metadata. The metadata may be representative of a variety of different content parameters, properties or attributes, for example but not limited to programme title, time, duration, content type, programme categorisation, actor names, genre, release date, episode number, series number. It is a feature of the embodiment that the metadata stored at the EPG module 8 and the VoD module 10 may also be enriched with additional metadata, for example by the operator of the system, such that additional metadata to that provided by the content sources or other external sources may be stored. The content information also include synopses and other descriptive data for content items.

In the embodiment of FIG. 1 the system operates together with three sources of content for a user device: real-time linear television, for example terrestrial or satellite broadcast television; one or more video-on-demand (VOD) services, and pre-recorded video content stored on one or more personal video recorders (PVR). In alternative embodiments, further sources of content as well as or instead of those shown may be used.

The operation of the digital content recommendation system is controlled by the recommendation system 2. As can be seen in FIG. 1, the recommendation system 2 is configured to communicate with the one or more content information modules: the electronic programme guide (EPG) module and VoD module 10. The recommendation system 2 is also configured to communicate with the user cache 6 local to the recommendation system 2, the hard disk storage resource 4 and the one or more PVRs. A data access layer provides a communication interface between the recommendation system 2 and the hard disk storage resource 4. A personal video recorder (PVR) communication module 12 provides a communication interface between the one or more PVRs 20a, 20b, . . . 20z and the recommendation system 2.

As discussed in more detail below, the user profile module 26 is operable to use first party data obtained by an operator of the system to determine user activity profiles of individual users 205 or sets of users 205, that are representative of actions of a user 205 with respect to content selection interfaces. The content recommendation engine (CRE) 22 can apply a set of processes to determine, in real time, content recommendations for a user 205 based on user data and available content.

The recommendation system 2 has a content recommendation engine (CRE) 22, item based procedure executing module 26 and a user learning module 24. The CRE 22 can apply a set of processes or procedures to determine, in real time, content recommendations for a user based on user data and available content.

The user learning module 24 receives data indicative of selections or other actions by a user and builds up a set of user data, for example comprising or representing a user history or profile, which is stored in the hard disk storage 4, and which is used in generating personalised recommendations for the user.

The UX engine 12 allows for the content selection interface to be configured, which may be at least in part responsive to input from an operative, such as an operative of a content provider service, and/or at least in part automatically, or any combination thereof.

The UX engine 12 allows groups of content to be created. The user content selection interface presents the content items for selection by the user 205 in the groups of content. In an example, each group of content may correspond to a different carousel in a carousel type user interface, but the present disclosure is not limited to this. In some examples, at least one or each group of content may represent a different theme, such as war movies, romances, action movies, nature programs, news and current affairs, and the like. However, this need not be the case, and at least one or each group could be simply selected by the operative or another party. The UX engine 12 also allows the way in which the groups of content are provided or displayed to the user 205 to be customized to that individual user 205 or group of users 205. For example, the UX engine 12 allows customization, e.g. automated customization, of the order in which groups of content are provided to the user in the user content selection interface, which may be an order in which the carousels corresponding to different groups are provided in the content selection interface. In some examples, this comprises allowing selected groups of content to be fixed in a set place in an ordering of the groups of content. In examples, this comprises allowing the UX engine 12 to determine a customized ordering of at least some or all of the groups of content for each user 205 or group of users 205, which may be based at least in part on groups of content that the user 205 or group of users 205 have previously interacted with in some way, e.g. whilst using a user content selection interface.

The ordering of the groups of content (and content recommendations in examples in which the UX engine 12 is part of a recommendation system 2) can be based on user actions, wherein at least some of those user actions include user interaction with content recommendation user interfaces. FIG. 1 shows user actions and requests for recommendations or ordering of content being communicated directly to the recommendation system 2 from the user devices 40. In addition to receiving requests for recommendations of content or ordering of groups of content, the recommendation system 2 is configured to log user activity. By logging user activity and storing activity over an extended period of time, the recommendation system 2 and the hard disk storage 4 can build up an overall picture of the actions of a plurality of users relating to their interactions with content selection interfaces. User actions are turned into learn actions by the user learning module 24 to be processed by the user profile module 26, the UX engine 12 and the content recommendation engine 22.

FIG. 1 shows a user action being received by the recommendation system 2. In addition to receiving requests for recommendation, the recommendation system 2 is configured to log user activity. By logging user activity and storing activity over an extended period of time, the recommendation system 2 and the hard disk storage 4 can build up an overall picture of the viewing activities, habits and preferences of a plurality of users. User actions are turned into learn actions by the user learning module 24 to be processed the content recommendation engine 22.

FIG. 1 also has a further metadata source. In the present embodiment, this is provided on a remote computer, accessible, for example, via the cloud 215. It will be understood that the further metadata source is provided remotely from the content recommendation system and, for example, data sources 8 and 10.

The system of FIG. 1 is configured to operate with a plurality of user devices each associated with at least one user. The plurality of user devices may comprise a large number of devices, for example thousands, tens or hundreds of thousands, or even millions of devices. Each user device may be any device or combination of devices that is configured to enable a user to view or otherwise consume content. For example, each user device may be an internet-enabled device and/or a device for providing video or other content on demand and/or a device capable of receiving a real-time linear television broadcast signal. The user device may be a mobile device, for example a tablet, a smart phone or a laptop. Alternatively, the user device may not be mobile, for example, an internet browser enabled computing device, a smart television or a set-top box. The user device may also have an in-built or associated PVR for recording and storing content in some embodiments.

The user 205 may be a viewer of the user device. Alternatively or additionally, the user 205 may be a subscriber and/or customer of a service accessible through the user device.

The user cache 6 is coupled to the item based recommendation procedure module 26 and the content recommendations engine 22, and the UX engine 12 and data stored by the user cache 6 may be used by the item based recommendation procedure module 26 and the content recommendations engine 22. The recommendation system 2 can access data stored on the user cache 6. The user cache 6 may be provided in random access memory (RAM) 7.

The hard disk storage 4 is communicatively coupled to the recommendation system 2. The hard disk storage 4 stores data for use by the recommendation system 2. The hard disk storage 4 is configured to store one or more databases. Entries from the databases on the hard disk storage resource 4 can be retrieved by requests made through a data access layer. Entries in the databases may also be updated via the data access layer. The database(s) at the hard disk storage 4 store user data that is used by the CRE 22 to generate content recommendations. In the embodiment of FIG. 1 a set of database tables is provided that store information concerning the users.

In the embodiment of FIG. 1, the tables may include at least one user service table 36 that represent user service requirements, and at least one user profile table 30 that includes user attribute data that may be considered to represent a user profile. A user profile may include, for example, the following attributes: unique identifiers, for example a user identifier, a subscriber identifier, an anonymous session identifier; one or more unique geographic identifiers; a flag indicating whether or not the user has a PVR; a flag indicating whether or not the user is in debt; a flag indicating whether or not the user has opted out of receiving marketing material; one or more codes indicating one or more preferred languages of the user; a flag indicating if the user has opted out of receiving personal recommendations; the age of the user; the name of the user and the gender of the user. A user profile may include user data and associated content metadata.

In the embodiment of FIG. 1, the tables may include various user learning tables that include data representing for example the viewing activities, habits and preferences of each user. The user data can include data representing for examples explicit ratings given by a user to a particular programme or other item of content. It is a feature of the embodiment of FIG. 1 that the user data also includes data representing actions, for instance viewing actions, taken by a user.

For example, if a user selects a programme or other item of content and views or otherwise consumes it for greater than a threshold period of time then a learn action is generated and at least one user data item for that user is stored in at least one of the tables. The data item may include various data including for example start and stop viewing time, time slot identifier, programme identifier, at least some metadata concerning the programme (although such metadata may be stored separately as content data rather than user data in some embodiments, and linked to or otherwise accessed if required, for example by the programme name or other identifier). The user learning module 24 determines whether user data should be stored in the tables in respect of a particular user action or set of actions. For example, if a user only views a programme for a very short period of time, for instance if they are channel surfing, then user data is not stored in the user learning tables in respect of that action. User data can be stored in respect of a variety of different user actions or events, for example selecting, viewing, recording or searching for content.

In the embodiment of FIG. 1, the tables may include various user learning tables that include data representing user 205 actions, also referred to as user activity, relating to content selection interfaces on a user interface; downloading content that is in a group of content or related group of content; having watched at least part of content that is in a group of content or related group of content; bookmarking content that is in a group of content or related group of content; browsing content that is in a group of content or related group of content; recording content that is in a group of content or related group of content; adding content that is in a group of content or related group of content to virtual shopping basket or otherwise selecting for purchase or potential purchase; watching or listening to a trailer for content that is in a group of content or related group of content; playing content that is in a group of content or related group of content on a user device; purchasing content that is in a group of content or related group of content; clicking on or otherwise selecting content that is in a group of content or related group of content from a list of search results; remotely recording content that is in a group of content or related group of content; setting a reminder for content that is in a group of content or related group of content; liking, making a favourite or otherwise adding to a list content that is in a group of content or related group of content; disliking content that is in a group of content or related group of content; messaging about content that is in a group of content or related group of content; posting on social media about content that is in a group of content or related group of content; playing purchased content that is in a group of content or related group of content; stopping watching or playing content that is in a group of content or related group of content; and/or rating content that is in a group of content or related group of content, from amongst others.

For example, if a user 205 selects a programme or other item of content from a content selection interface and views or otherwise consumes it for greater than a threshold period of time then a learn action is generated and at least one user data item for that user is stored in at least one of the tables. The data item may include various data including for example start and stop viewing time, time slot identifier, programme identifier, which group of content the content belongs, at least some metadata concerning the programme (although such metadata may be stored separately as content data rather than user data in some embodiments, and linked to or otherwise accessed if required, for example by the programme name or other identifier). The user learning module 24 determines whether user data should be stored in the tables in respect of a particular user action or set of actions. For example, if a user only views a programme for a very short period of time, for instance if they are channel surfing, then user data is optionally not stored in the user learning tables in respect of that action. User data can be stored in respect of a variety of different user actions or events, for example selecting, viewing, recording or searching for content or any of those listed above or others that would be apparent to a skilled person.

In the embodiment of FIG. 1 it can be understood that a large part of the user data comprises user history or user action data that represent user actions over a significant period of time. In various embodiments, there is a limit to how long user data is kept or used. For example in the embodiment of FIG. 1 after a threshold period, for example six months after being collected, items of user data are deleted. Thus, in some embodiments the user data for a particular user may include only relatively recent user action data, although the amounts of data may still be substantial.

In the embodiment of a FIG. 1, a distinction is made between different types of user and different sets of the tables are stored for the different types of users.

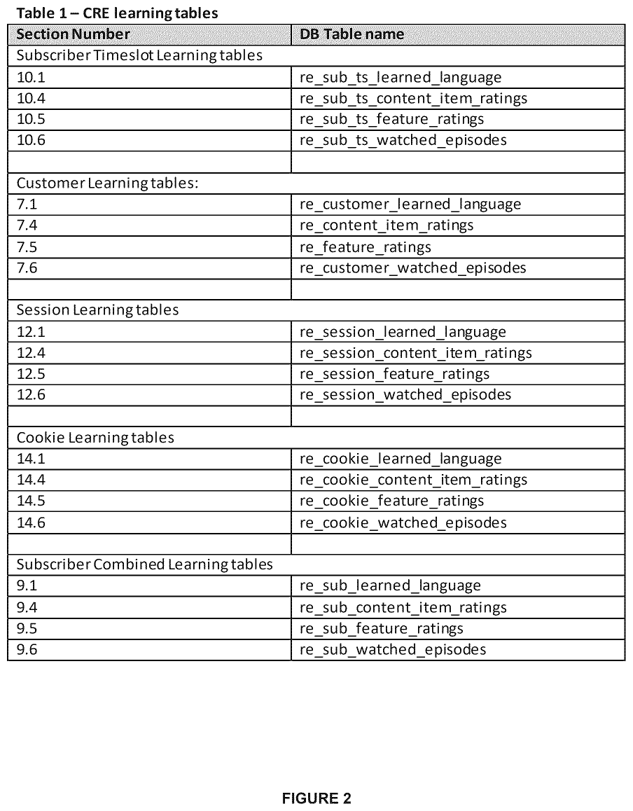

FIG. 2 is a representation of certain database learning tables stored on the hard disk storage resource 4 of the embodiment of FIG. 1. The system supports different categories of user. The tables of FIG. 2 correspond to different categories of user. The categories in this embodiment are: customer, subscriber and anonymous. Subscriber can, for example, refer to combined subscriber mode or time-slot subscriber mode. Anonymous can, for example, refer to cookie and/or session modes.

A customer may be a user who uses a service or content source. A customer profile may store one or more of the following attributes in some embodiments: preferred features; indication of preferred viewing times e.g. day, start and end times. The customer profile table also stores a list of the favourite content item group information: content source (e.g. EPG or VOD) and unique identifiers for content item groups.

A subscriber may be a person who has subscribed to a particular service rather than the individual who is using the service. For example, the subscriber can be an account holder or an entity that represents a household. Individual users may be associated with a subscriber. There are at least two modes of operation of subscriber profiles. The first is combined mode, where data for the subscriber (for example attributes and/or subscriber actions) are used to generate content recommendations. In that case, the content recommendations may be based on attributes and/or user actions for a plurality of individuals associated with the same subscription, for example different members of the same household. The second is time-slot mode where content recommendations are generated in dependence on the particular time slot in question. For example user data generated for a particular time slot may be used selectively in generating content recommendations for a particular time slot (potentially with user date generated for other times slots being ignored or weighted to be of less significance) and/or with different rules and/or attributes being used for different time slots. For instance, there may be a rule that no adult content be recommended for morning or afternoon time slots, only for late evening or night-time time slots. Similarly, greater weighting may be given to children's programmes for certain time slots, for instance late afternoon time slots, making recommendations of children's programmes more likely during those time slots.

Anonymous profiles are used to recommend content when neither the individual customer or subscriber to a service is known. For example, for a web user who has not logged in is an anonymous user. There are two modes of operation of anonymous profiles. These are session mode (either single-session or multi-session mode) and cookie mode.

In single-session mode preferences of the anonymous consumer are stored in memory for the duration of a single session and then removed from memory at the end. In multi-session mode preferences of the anonymous consumer are kept in memory over more than one session. The anonymous profile is identified over more than one session using a unique session id stored in the anonymous profile.

In cookie mode, the recommendations engine 22 can perform anonymous session tracking using cookies, wherein on a first request a cookie containing the unique identification is added and in later sessions used to identify the anonymous user. This works in a web environment. A cookie session profile holds a list of cookies that are known to the system together with data referring to when the cookie was created or last accessed.

For each user of all categories, there may be separate groups of learning tables. In FIG. 2, the learning tables shown are “learned language”, “exclude content group”, “content item ratings”, “feature ratings” and “watched episodes”. These tables are shown by way of example. Other tables may also be stored in the embodiment of FIG. 1. Each user may have explicit preferences and implicit preferences. Explicit preferences are information the consumer tells the system by, for example, by entering a questionnaire. Implicit preferences are information learned by the system through user actions. Data corresponding to user actions for the purpose of learning are stored in the learning tables.

The learned language table 32 stores data relating to audio languages of content items that have been user actioned by the user. For example, the feedback table can store learned language information, the date at which the language was learned and an indication of whether or not the entry has been aged out.

The exclude content group table stores data corresponding to content explicitly excluded by the user. For example, the feedback tables also contain information on content items and content item groups that have been manually excluded by the customer. For example, for individual content items that have been excluded this information includes: identifier of the content item; content source; data and time of exclusion; series title of content item; client type ID (e.g. web, call centre, set-top box). For content item groups, this information includes: customer identifier, time and date content item group excluded; content source; client type ID. In both case, a flag is included that indicated whether or not the exclusion has been aged out.

The content item ratings table stores data representing features of content such as the features, actors, channels. Feature ratings allows learn actions to specify features of content information instead of the content item. A customer is capable of applying ratings to a content item. Rating information is stored in the customer feedback table and includes: time and date rating given; customer identifier; activity identifier; name and identifier of content item rated; content item group identifier if content item associated with a content item group; rating value; a scaled rating value; feature ratings; content source ID; client type ID; series title of content item and content item instance identifier. A flag is also stored to indicate if a recommendation has aged out or not. A feature rating made by a customer can also be stored on a specific list of features and/or sub-genres.

The watched episodes table stores data corresponding to last actioned episode of a series actioned by a user. For example, for each customer the episode history for customers is stored. This includes a series identifier; a series title; a season and episode number, and the date and time the user action occurred.

In alternative embodiments, different data tables or combinations of data tables may be stored.

It can be understood from the description above concerning user learn actions that in a system with a large number of users, user data may be generated almost continuously as users watch programmes and perform other actions. Such user data is stored in the hard disk storage 4.

It can be understood from the description of the nature of the user data, that for a particular user there may be large numbers of individual data items for each user, for example there may be individual data items for each individual relevant user action over the preceding 6 months or other predetermined or selected time period. For example each learn action (e.g. each time a user has watched or recorded a programme at any time during the previous six months or other relevant time period) will have its own data item (e.g. table entry) in the user data. Thus there may be several hundreds or even thousands of data items (e.g. table entries) that need to be read from the hard disk storage 4 for a particular user.

It is a feature of the embodiment of FIG. 1 and at least some other embodiments that during a session for a particular user, the user data for that user may change or be added to. For example, a user may carry out a number of user actions. These may include, for example, switching channel or selecting new content items, watching a content item, pausing a content item, logging in and out of the service, recording of a content item on a PVR or other recording device, or even selecting a piece of content based on a content recommendation provided earlier in the content recommendation session. User actions are logged by the recommendation system 2 during the session. Some of these user actions are recorded as learn actions during the session. As discussed, the user learning module 24 has a set of rules for determining which user actions are learn actions.

A learn action may be based on an indication that a user has watched a content item for a specified period of time. The information may be used as an indication of user preferences. As discussed, a minimum event time filter may be implemented to ensure that short period events are not recorded and/or used. In this case, a learn action is only generated if an event exceeds the minimum event time filter. In addition, there may be a rule that only one learn action for each content item should be generated. For example, a viewer may watch a programme and switch channels during an advert break and then return to the original programme. In such an event, only one learn action may be generated according to some embodiments.

New user data, for example new table entries, corresponding to the learn actions for the user ultimately are stored in the hard disk storage 4. However, it is a feature of the embodiment of FIG. 1 and of at least some other embodiments that user data for the user stored in RAM 7 during a session for that user is updated, based on the learn actions for the user occurring during the session, on an ongoing basis. Thus, the user data for a user stored in RAM 7 may change during a session for the user, such that processes are performed based on the most up-to-date user data.

In the embodiment of FIG. 1, the user data for a user is overwritten by the user data stored in RAM 7 (which may be more up-to-date) in response to the end of a session for the user. For example, the updated user data can be provided to the hard disk resource 4 in response to an expiry event. An expiry event may be a user action corresponding to a user terminating a session, terminating watching a content item (e.g. the end of a programme playback) or terminating recording of a content item. Alternatively an expiry event may occur a pre-determined period of time after a user action. For example, an expiry event may be a pre-determined period of time elapsing after a user action corresponding to a user commencing a viewing session.

In some embodiments, all of the user data for the user stored in the hard disk storage 4 may be overwritten by the user data stored in RAM 7. Alternatively, only changes to the user data may be written from RAM 7 to the hard disk storage 4. In some embodiments user data is written to the hard disk storage 4 periodically or in response to at least one of processing capacity or communication capacity being available. Higher priority may be given to updating the user data in RAM 7 than to updating the user data in the hard disk storage 4.

In some embodiments, the user data for a user may be maintained in RAM 7 after the end of a content recommendation session for the user and only deleted from RAM 7 in response to the user data from RAM 7 having been written to the hard disk storage 4.

In at least some other embodiments, each time new user data is generated (for example, when a learn action is generated during a session for a user) it is written both to RAM and to the hard disk storage 4. Thus, an attempt may be made to maintain up-to-date user records for the user in parallel in both RAM and the hard disk storage 4. For example, one option is to provide the updated user data to the hard disk storage 4 at substantially the same time as updating the user data in the user cache 6. Alternatively, priority may be given to maintaining up-to-date user data in RAM 7, with the user data in the hard disk storage 4 only being updated on an as-and-when basis.

Information relating to content available on a real-time linear television broadcast may also be received by the user device and is typically presented to a viewer via an electronic programme guide. The electronic programme guide is interactive. The information relating to the real-time linear television broadcast may be provided by either the service provider or by a third-party content information provider. The information may be delivered to the user device as part of the broadcast or may be provided through alternative means. For example, an internet enabled set-top box may receive a satellite broadcast carrying the content but receive information relating to the broadcast via an internet connection.

The user devices of the system of FIG. 1 comprise or have associated with them local storage devices in the form of PVRs, and each PVR may be considered to represent a content source. Each user may have a PVR for recording broadcasted content and/or for downloading and storing previously broadcast content. The PVR may be part of a user's set-top box or it may be a separate device. The recorded content is stored on a memory of the PVR to be viewed at a later time. FIG. 1 shows a set of n personal video recorders: PV1, PV2, . . . , PVn. Each PVR corresponds to a different user. Each PVR has a collection of content recordings stored on their respective memories. Typically each PVR will have a different selection of stored programmes from the other PVRs. However, more than one PVR may have one or more common programmes stored on their memories at a given time. For example, user of PVR1 and user of PVR2 may have recorded or downloaded the same content item or series of content items. Each PVR may have content items that are not available from other content sources, for example because they are not made available on VoD or have not been re-broadcast. This may also be a result of the age of the content item. For example, the content item may have been available for a certain amount of time from another content source but is no longer available.

In alternative embodiments, the PVRs or other data stores for storing content for users may be implemented in forms other than local storage devices. For example, the data stores may be implemented as storage areas in a cloud storage system or other networked, remote, and/or virtual storage system.

The PVR communication module 12 of FIG. 1 is an interface between the PVRs 20a, 20b, . . . 20z and the recommendation system 2. The recommendation system 2 collects identifying information relating to the content items stored on the PVRs 20a, 20b, . . . 20z. Content items from the PVR of the user can then be taken into consideration in generating content recommendations.

In alternative embodiments, any other data stores, for instance local storage devices, for example any storage devices included in or associated with user devices, may be used as well as or instead of PVRs. In some embodiments, the data stores may comprise data stores forming part of a cloud storage system or other remote and/or networked and/or virtual storage system. Furthermore, the items of content in question are not limited to comprising video content and may comprise any suitable type of content, for example audio content, image content, virtual reality content or augmented reality content.

There is description above concerning metadata or other content information that may be used by the system. Content metadata and/or information may, for example, include contain scheduling information (e.g. start and end times for programmes, series information) together with content information regarding the programme itself (e.g. programme description, age rating information).

Content items, for example programmes, that are scheduled in an electronic programme guide have associated content information (metadata). Information about content available from this source is stored in the EPG content source table. In a similar fashion to EPG content items, information for video on demand (VOD) content items are stored on the VOD module 10. EPG content items and VOD content items sharing certain characteristics can be arranged into groups. In addition to above, content items are stored on PVRs and have associated information. A group of EPG content items may be considered as equivalent to a broadcast television channel. VOD content items can be grouped into logical groups, for example, movie categories. VOD content item groups can be used to enable or restrict access to content items on a per customer basis. PVR content information is collected and stored in the PVR table 32.

For each content item group, either EPG or VOD, the information that is stored may include: an identifier for the group; a name for the group; a flag indicating if the group is free to view and therefore available to all customers; an indicator of video format of the group e.g. unknown, standard definition, high definition and 3D; one or more language labels; primary and secondary geographic area information. Concerning VOD content item groups, the primary and secondary geographic information can be used to allow customers from different countries access to different content. If the group is associated with a channel then an identifier and mapping to the channel may also be stored. One or more content item groups can be associated with a channel number.

Single content items (e.g. programmes) also have associated information and characteristics. Stored content item information can be constant or variable. Constant content item information has values that are the same for all instances of the content item. Variable content item information has values that vary between different instances of the content item. For example, the same episode may be shown at two different times. The two instances of the same episode share constant characteristics, such as duration and rating but different schedule times, for example.

Constant content item information includes: a unique identifier; duration of the content item; the certificate of the content item e.g. the age rating; the year the content item was released; the critic rating for the content item; the original audio language for the content item; the season and episode numbers; series title information and/or identifier; content item description, and a primary language. The primary language may or may not be the same as the original audio language. For multi-language content items, translations of the title and description can be stored. Furthermore, available broadcast language information can be stored and an indicator to indicate the type of language available. For example, the language may be primary audio language, dubbed audio, subtitled and/or signed.

Further information stored for content items includes: genre and sub-genre information and names associated with the content item. A given name can be associated with, for example, an actor or director involved with or appearing in the content item. For a given name associated with the content item, an identifier for the role in the content item is also stored. In addition, an indicator of the rank of importance of the name and/or the role in the content item may be stored. The rank may be high for a more important role in the content item. For example, a given actor playing a leading part would be assigned the highest rank available.

Although the system of the embodiment of FIG. 1 includes hard disk storage 4 and RAM 7, any suitable other memory devices or types of storage may be used as well as or instead of the hard disk storage 4 and/or RAM 7 in alternative embodiments.

As part of a session, the content recommendation engine is configured to offer a number of operations to be called using an API. As an example, the content recommendation engine is configured to offer to content recommendation request

A user 205 watching a television programme that they have selected on user device 40. Data representing the user's activity is sent to the recommendation system 2 and a learn action, as mentioned above, is performed that results in at least one user data item for that user being added to at least one of the tables. The user data item may comprise data concerning the item of content and data concerning the viewing, for example start and stop times for the viewing.

The collection of data items stored in the tables concerning the user, for instance, viewing of content by the user may be referred to as a user record for the user. The user record may also be referred to as a user profile.

As a non-limiting example, a user record or user profile may include information that a user has played an episode of Game of Thrones on 14 Jul. 2022, has downloaded an episode of The Simpsons on 15 Jul. 2022, and has just watched an episode of Top Gear on 15 Jul. 2022. The user record will also include metadata associated with each item of content in the record. For example, the meta data items cars, supercars and engineering are associated with the Top Gear episode. In practice there will be many more items of meta data associated with each item of content. In general, a user record will include records of far larger numbers of items of content. However, such a small number of items content might be found for a new user or for a temporary user of a system. For example in some embodiments, the system may be used for a user who is a guest in a hotel or traveller in a vehicle or transport system.

The user data in respect of the user is sent to the content recommendation engine 22 (of the content recommendation system 2) in order to generate or update a user profile for the user 50.

The content recommendation module 22 in this embodiment then performs a search of various data sources, for example in the cloud, to determine any other information concerning the item of content. The data sources can include EPG module, VoD module and other data sources. For example, various databases can be consulted that include additional information concerning television programmes or other items of content.

In the present embodiment, the record for the item of content and any other information found from the search of data sources is subject to processing to match the meta data and other information for the item of content to an ontology of meta data terms that are maintained by the system. Thus, the meta data for the item of content can be enriched, corrected or supplemented.

In the present embodiment the ontology consists of around 38,000 features that can be used as meta data to represent items of content. The ontology defines features in the format <context>:<keyword>. Features describe the content and include subjects, settings, themes and characters (for example, Wimbledon may contain the terms—subject: tennis, sports competition: Wimbledon, theme: sports). Any other suitable ontology can be used in other embodiments. In some embodiments, no ontology is used and the raw metadata associated with the item of content (for example, provided by the content maker, distributor or broadcaster) is used without amendment or enrichment.

The metadata for the item of content is then stored in the user record or user profile in the user profile table 30 in the hard disk storage 4.

As described above, each user has a stored user record or user profile. The system is configured to provide a plurality of content recommendation candidates to a user based on the similarity between the user record and the content metadata.

Operation of the system of FIG. 1 is described in the following. As a first stage, the user 205 initialises a viewing session through a first initiation event. An initiation event can, for example, be a user logging on to a service provider or turning on the user device 40. The initiation event is communicated to the content recommendation module 2 via a communication channel between the user device 40, for example a set top box or other device, for example at the user's home or other remote location, and the content recommendation module 2. In the embodiment of FIG. 1 there is direct communication between the user device 40 and the content recommendation module 2. In alternative embodiments, communication between the user device 40 and the content recommendation module 2 is mediated or passes through, for example a content provider, for instance a TV system operator to which the user subscribes. The initiation event may be treated automatically by the content recommendations module as being a request for recommendations for the user.

In response to the initiation event, the user is then presented, via a display of the user device 40, with a content selection screen displayed on a display screen and/or user interface, which presents the user with a choice of viewing different content items from the content source. For an EPG content source, the content selection screen may form part of the EPG itself. For a VoD content source, a dedicated user interface may be presented. It is a feature of the embodiment of FIG. 1 that the choice of content items includes content recommendations generated by the content recommendation system of FIG. 1 and communicated to the user device. In one mode of operation it is a requirement that the content recommendations should be provided almost instantaneously, for example within a few hundred milliseconds, so that they can be included on the user interface together with other available items of content, for example live TV schedules, as soon as the user interface is displayed to the user.

In response to the initiation event a start time to the viewing session is logged by the CRE 22, for example, to coincide with the initiation event, a content recommendation session is opened and user data, associated with the user, are retrieved from storage on tables in the hard disk storage resource 4 and loaded to the user cache 6 in RAM 7. The user data are maintained in RAM 7 throughout the content recommendation session.

The CRE 22 also maintains content data in the RAM 7, for example any suitable data relating to properties of the content, such as metadata obtained from the EPG module 8 and the VoD module 10. The content data stored in RAM 7 may be updated periodically or in response to changes in the data stored, for example, at the EPG module 8 and VoD module 10. By caching the content data in RAM processing and data access speed may be increased.

Following retrieval of user data and obtaining content source information, the CRE 22 is configured to use the user data located in the user cache 6 together with the available content information as part of a content recommendation process.

Once the CRE 22 has performed the content recommendation process, the content recommendation(s) generated by the CRE 22 are then transmitted to the user device 40 either directly or indirectly. In some embodiments the content recommendation(s) are transmitted to a database, server or other device, for example a third party device. The content recommendation(s) may be further processed and/or may be transmitted onward to then user device either immediately, at a later time or upon request. The content recommendation(s) may be transmitted in any suitable fashion either to the user device, or to the database, server or other device. In the present embodiment, software installed at the user device 40 determines whether or how the content item recommendation are displayed on the user interface.

It can be understood that the time constraints on providing content recommendations can be significant, given that personalised content recommendations may need to be generated on the fly, particularly as it may be necessary to provide personalised content recommendations for tens of thousands, hundreds of thousands, or even millions of users substantially simultaneously in the case of systems with large numbers of users and during busy periods such as peak viewing periods.

It will be understood that the CRE 22 may maintain content recommendation sessions for a plurality of the users and may maintain in the RAM user data for said plurality of the users substantially simultaneously. For example, user data may be maintained in the RAM 7 for thousands, hundreds of thousands or even millions of users substantially simultaneously, depending on the RAM storage capacity available and the number of subscribers or other users associated with the system.

At the start of a content recommendation session for a user the user data, including all of the various table entries, for the user, are read from the hard disk storage 4 and stored in the user cache 6 in RAM 7, or any other suitable local or rapidly readable storage resource in alternative embodiments. Throughout the content recommendation session the user data stored in the user cache 6 in RAM 7 is used by the CRE 22 to generate content recommendations for the user. This can provide a significant time saving compared to having to read the user data from the hard disk storage 4 each time a content recommendation is needed during the session. At the expiry of a session, the user data for the user is deleted from the cache. The expiry of the session may occur for example in response to no user actions have been received for a pre-determined time period, in response to a user logging off a session or switching off a user device, or in response to loss of communication with the user device. If a new content recommendation session for the user subsequently begins, the user data is read again from the hard disk storage 4 and stored in the user cache 6 in RAM 7.

There is description above concerning metadata or other content information that may be used by the CRE 22 in providing content recommendation. The content information can contain scheduling information (e.g. start and end times for programmes, series information) together with content information regarding the programme itself (e.g. programme description, age rating information). In some embodiments, metadata items may be mapped from an ontology (e.g. the ontology of 38,000 items) to other metadata items in the ontology. Weightings or confidence scores are associated with the mappings in some embodiments. The ontology represents a pre-determined set of properties and/or parameters. The content metadata for content items (or as collected in user data) corresponds to properties and/or parameters selected or assigned weights and/or values from this pre-determined set. The at least one property of the piece of content may comprise a set of tags or other metadata representing properties of an item of content. In the system, the metadata is stored on hard disk storage in metadata table 33.

As part of a content recommendation session, a number of different types of recommendation procedures may be available to be requested. These include procedures, for example based on a weighting, scoring and/or matching process generated based on previous user actions, and matching to available content. In a simple example, if it is determined from the user data that a user has previously watched movies starring a particular actor, or watched football matches featuring a particular team, then the CRE 22 may produce a recommendation for the user to watch a movie or other content featuring that actor, or a programme concerning that football team, if such movie, programme or other content is currently available or will soon be available via the available content sources. It will be understood that the content recommendation procedures may be more sophisticated and, may be for example based on similarities or cross-correlations between different content parameters and user actions and properties based on large amounts of historical data. At least one of the recommendation procedures may use a machine learning derived model to determine recommendation candidates. As a non-limiting example, machine learning techniques such as clustering algorithms for clustering objects that share similarities, such as K-means clustering or neural network based techniques and/or Kohonen based techniques may be suitable.

The content metadata may correspond to values for one or more properties or parameters or characteristics, such as programme title, time, duration, content type, programme categorisation, actor names, genre, release data, episode number, series number, style, mood, language and theme. The properties or parameters or characteristic may include one or more of the following: Audience; Award; Category; Character; Character Type; Concept Source; Director; Format; Franchise; Host; Milieu; Mood; Producer; Person; Subcategory; Scenario; Setting; Sports Competition; Studio; Style; Subject; Team; Theme; Time Period; Writer. These properties or parameters will be understood as a non-exhaustive and non-limiting list. The metadata is represented by metadata items having a value for such properties or parameters. The collected metadata can be considered as representative of user interests and/or preferences based on previous interactions with the content. The metadata items may be provided together with a score so that the metadata represents a degree of the preference or interest for that content property or parameter. The content metadata of the user data may be referred to as user profile features. Content metadata attributes may also be referred to as facets. The following, non-limiting and non-exhaustive list of facets is provided: Actor; Audience; Award; Category; Character; Character Type; Concept Source; Director; Format; Franchise; Host; Mileu; Mood; Producer; Person; Subcategory; Scenario; Setting; Sports Competition; Studio; Style; Subject; Team; Theme; Time Period; Writer. It will be understood that in addition to facets, a number of other categories of content attributes may be used. For example, the desired context may be defined, at least in part, by descriptive content metadata or alternative content characteristics, such as, running time, language, format, age rating. In general, any property or parameter or characteristic capable of distinguishing a sub group of available content from other available content can be used as a content attribute or content metadata. For example, metadata categories as described above or other content information may be suitable. It will be understood that a context can correspond or represented by combination of context attributes. In some embodiments, the context may be associated with at least some of the content that is currently being displayed to a user via the user device.

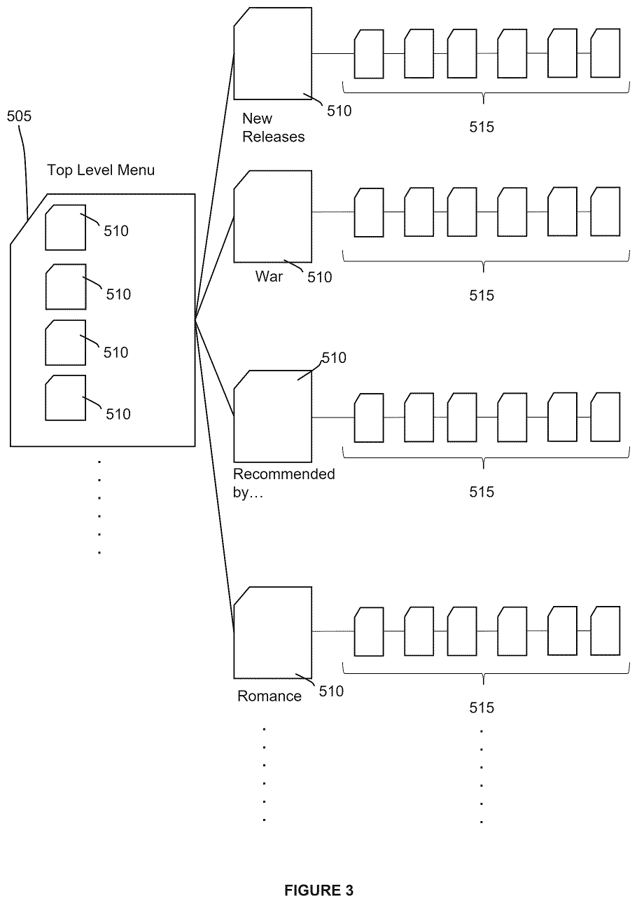

FIG. 3 shows a file structure for storing the groups of content. A high level folder 505 can contain all or at least a plurality of the groups of content 510 available for a given content provider or a different service of a content provider 210. The service provider may have one or multiple high level folders (e.g. corresponding to different services, subscriptions, seasons or the like or simply may contain different groups of content that are in some way related or grouped together for ease of organisation or administration). The dots in the Figure indicate the possibility of one or more additional similar features. Each high level folder 505 may apply common settings to the groups of content 510 within that folder 505. For example, a flag for a high level folder 505 can be set to “fixed”, which would mean that the positions of all groups of content 510 in that folder 505 in an ordering of groups of content 510 for display on the content selection interface would be fixed or a flag for a high level folder 505 can be set to “customizable”, which would mean that the positions of all groups of content 510 in that folder 505 in an ordering of groups of content 510 for display on the content selection interface would be dynamically customized for that user 205 or group of users 205 based at least in part on a number of user actions recorder for that user in relation to the relevant group of content 510. In some examples, the high level folder may be a top level or root folder but could be any folder that would be useful to organise the groups of content. This arrangement may allow operatives to more quickly configure content selection interfaces by allowing settings to be quickly applied to multiple groups of content 510 by arranging them into folders 505.

Each high level folder 505 comprises a plurality of groups of content 510. As noted above, each group of content 510 may simply comprise a plurality of content items 515 selected by an operative or may comprise content items 515 that correspond to a common theme associated with the group, such as “new releases”, “war”, “recommended by . . . «recommender»”, “recently added”, “previously viewed”, “romance”, “liked”, “suitable for age «age of user»”, “recommended “favourites”, “because you watched . . . «related content»”, and/or the like. It will be understood that these examples are provided as non-limiting examples, and the groups of content may be generated using a number of methods, for example, as part of a content recommendation process or otherwise.

The UX engine 12 can tailor the order in which at least some of the groups of content 510 are provided to the user 205 in the content selection interface, based at least in part on user actions, e.g. number of user actions, relevant to particular groups of content 510 made during their use of the content selection interface. Importantly, whilst the content recommendation engine (CRE) 22 is configured to recommend content items 515 that may be of interest to the user 205 (e.g. which can be used to generate the groups of content 510 that may be of interest to the user 205, for example by selecting content items 515 for each group 510), the UX engine 12 is operable to optimize the order that the groups 510 are presented to a user on a content selection interface. Thus, the CRE 22 has a purpose distinct from that of the UX 12.

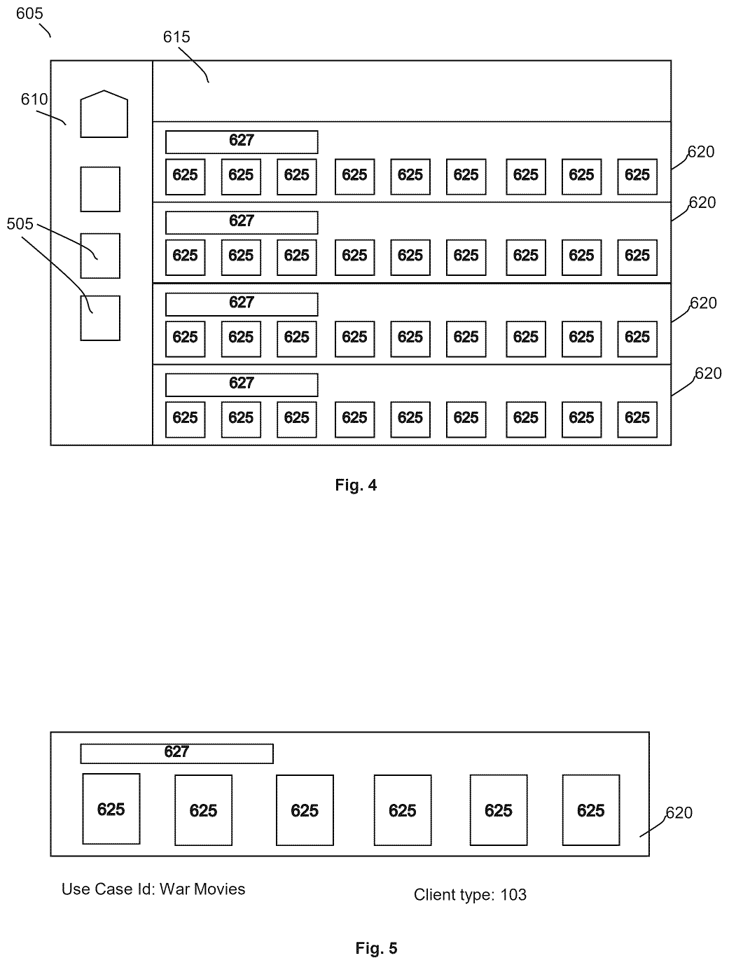

FIG. 4 shows an example of a content selection interface 605. In this example, the content selection interface 605 optionally comprises a high level menu bar 610 down one side that can contain functions such as “home page”, “search” and/or may show the high level folders 505 that are available for selection. In some examples, the high level menu bar 610 can be used to switch content provision services or users or switch high level folders 505, which may impact the groups of content provided by the content selection interface 605. That is, the groups of content 510 displayed and available for content selection will automatically update on selection of a service, user or high level folder 505 in the high level menu bar 610 to show groups of content 510 associated with that service, user and/or high level folder 505.

The content selection interface 605 further comprises a headline banner 615 that is optionally always fixed at the top of the content selection interface 605 or at least is provided as the first selectable item in the content selection interface 605 at least until such time as an operative may change the headline banner 615.

Beneath the headline banner 615 is a plurality of carousels 620, each carousel 620 containing a respective group of content 510. In this example, each carousel 620 comprises a plurality of selectable content indications 625, each content indication representing a different contain item 515 that is contained in the group of content 510 represented by that carousel 520. Thus, in the content selection user interface, each carousel 620 corresponds to and shows a corresponding different group of content 510, and each content indication 625 represents and indicates a different item of content 515 from the group of content 510 that can be selected by the user 205 by selecting the corresponding content indication 625.

Each carousel 620 has a carousel indicator 627. The carousel indicator 527 include text corresponding to a generated descriptor.

The user 205 can scroll up and down through the carousels 620, with new carousels 620 representing different groups of content 510 appearing at the bottom and the top carousel 620 disappearing at the top as the user scrolls down through the carousels 620 and vice versa as the user 205 scrolls up through the carousels 620. When the user 205 identifies a carousel 620 corresponding to a group of content 510 of interest, the user 205 can scroll from side to side along the carousel 620 to scroll through the selectable content indications 615 representing the items of content 515 in the group of content 510 associated with that carousel 620.

A detailed view of a carousel 620 representing a group of content 510 from the content selection interface 605 is shown in FIG. 5, which shows a plurality of selectable content indications 625, each representing a different user selectable content item 515, and the carousel descriptor 627.

The content indications 625 may comprise a thumbnail showing an image of the item of content 515 and/or text indicating the name of the content 515 or the like. When the user identifies the content 515 represented by the content indication 625 that they want to consume, then the user 205 selects the desired content indication 625 from that carousel 620 to request provision (e.g. download, streaming or viewing) of the item of content 515 represented by that content indication 625. Of course, there are many arrangements of content selection interfaces and the present disclosure is not limited to the particular arrangement of content selection interface 605 shown in FIGS. 4 and 5.

For example, in alternative content selection interfaces, the user 205 can scroll through groups of content 510/carousels 620 horizontally (or in any other direction) and scroll through the content indications 625 representing content items 515 vertically (or in another direction that is different from the direction through which the groups of content are scrolled through). In such arrangements, the carousel indicator 627 may be displayed next to the carousel or, for example, as part of the headline banner 615.

In some embodiments, the carousel indicator is displayed separately from the carousel itself, for example, at a different part of the interface, for example, as part of the headline banner 615.

Some content selection interfaces may be arranged in a hierarchical structure, with the user able to drill down through groups of groups of content 510, into groups of content 510 and finally down into content items 515. However, various other arrangements would be apparent to a person skilled in the art and to which the concepts of the present disclosure could be applied and the present disclosure is not limited to the content selection interface 605 shown in FIGS. 4 and 5.

The content items 515 in the groups 510 or the groups 510 themselves can optionally be picked by an operative or selected by the content recommendation engine (CRE) 22 for that user.

The ordering of at least some of the groups of content 510 in the content selection interface 605 is customized/specifically determined for that user 205 based at least in part on previous user actions relating to, e.g. during use of, the content selection interface 605 (or other content selection interfaces 605).

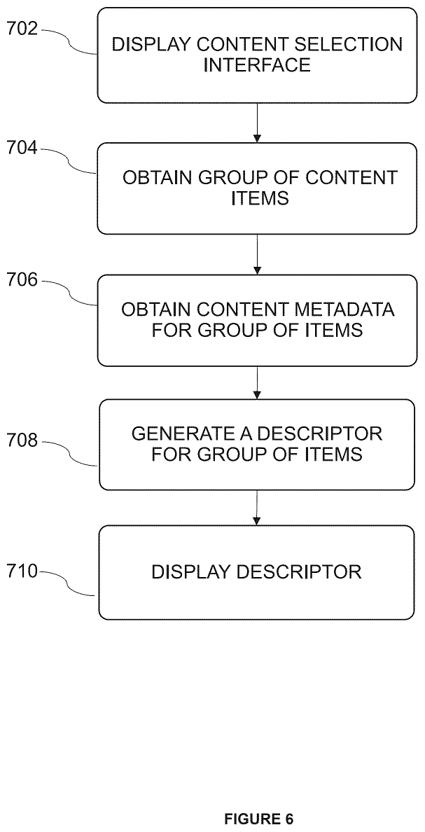

FIG. 6 is a flowchart of a method of generating a descriptor for a group of items, for a user. The method can be incorporated into a workflow, for example into a content recommendation workflow. Alternatively, the method may be performed independently of a content recommendation workflow. In the method of FIG. 6, the generation of the descriptor is based on content metadata for a group of items.

At step 702, a content selection interface is displayed on a user device. A user can scroll the content selection interface as described with reference to FIGS. 4 and 5. At step 702, a plurality of groups of content item recommendations may be obtained to allow at least a first page or screen of the content selection interface to be populated before a user commences scrolling through the content selection interface.

At step 704, a group of content item recommendations is obtained in response to receiving a user action. The group of content item recommendation may be obtained through a content recommendation procedure, for example, may be received in response to a request made by a content recommendation engine. Other methods of obtaining the content items for display on the content selection interface may be implemented, for example, as described with reference to FIGS. 4 and 5.

At step 706, content metadata for the group of items are obtained for the group of content item recommendations. In embodiments, the content metadata is obtained from, the metadata table of hard disk storage. In embodiments, the content metadata is obtained from the EPG module or VoD module. In embodiment, the content metadata is obtained from another data source, for example, from a third party. In some embodiments, the content metadata is combined with user data, for example, metadata from a user profile.

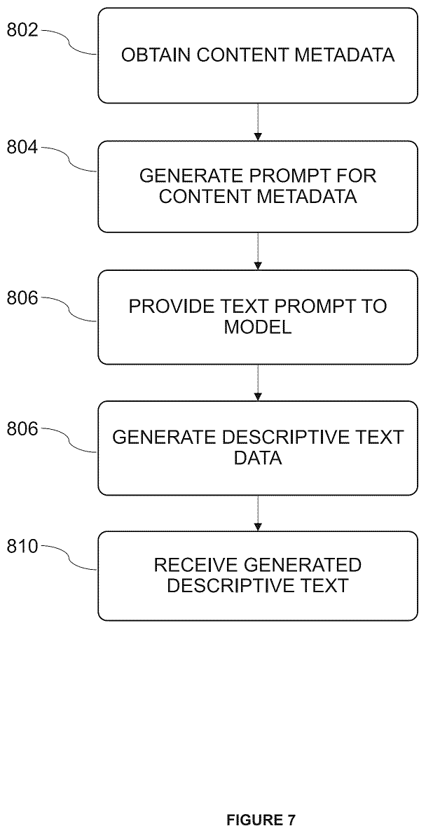

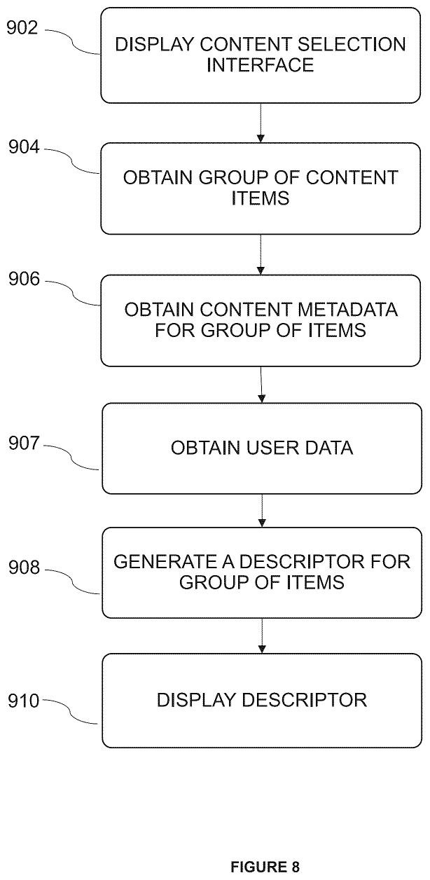

At step 708, descriptive text in the form of a descriptor for the group of items is generated. The generation of the descriptor is described in further detail with reference to FIG. 7. The generation of the descriptor is performed by processing the content metadata obtained for the group of items. In some embodiments, as described with reference to FIG. 8, the generation of the descriptor is customized to a user by processing content metadata together with user data.

At step 710, the descriptor is displayed on the content selection interface. In the present embodiment, the descriptor is displayed as the carousel indicator 627. The carousel indicator may also be referred to as a row descriptor.

In the method of FIG. 6, steps 704, 706 and 708 are represented as separate steps. However, it will be understood that one or more of these steps may occur substantially simultaneously or as part of the same process. For example, the content metadata for a group of items may be obtained at the same time that a list of the group of content items is obtained. In some embodiments, the content recommendation process may include generating the descriptor and the content item candidates returned by the content recommendation process may be provided together with the content item candidates.

FIG. 7 represents a method of generating descriptive text in the form of a descriptor for a group of items, in accordance with an embodiment. It will be understood that steps of the method of FIG. 7 may correspond to one or more of the steps, for example, step 708, of the method of FIG. 8.

At step 802, content information in the form of content metadata for the group of items is obtained. The content information may include enriched metadata about the content item.

Following retrieval of the content metadata, a processing step may be optionally performed to filter and/or reduce the amount of content metadata. Such a filtering step may reduce the number of content metadata items associated with a content item to a smaller numbers. The content metadata may be in the form of or may be used to populate a feature vector or other suitable mathematical representation for each of the group of content items. The one or more filtering steps may include selecting the features of the feature with the highest weight and therefore the most important features. Other filtering steps may be performed, for example, features may be selected based on category and/or other criteria. In some embodiments, the feature vector is truncated or constrained to be a particular size. In some embodiments, the filtering of the metadata is based on the weighting of the metadata against associated content items.

In some embodiments, each item of content is represented by a vector in a multi-dimensional vector space, where each component of the vector corresponds to a metadata category. As such, each content item may be represented as a vector in a high dimensional space, each dimension of the vector space corresponding to a metadata category. Each feature vector has multiple components, the size of each component representing the degree to which the content item represents that category of metadata. As such, the feature vector will have a largest component in the content metadata category that is best represented or matched to the content item.

At step 804, the prompt generator processes the feature vector generated at step 802, to generate a prompt. The prompt is in a suitable input format for the generative language model. In the present embodiment, the prompt is a text string. As a non-limiting example, the prompt may be in a human readable format, and is of the format: “Generate a description for the group of content items A, B, C having metadata X, Y, Z.” Alternative prompts may be in the form “Generated a description for content items having the following metadata: A, B and C”. In some embodiments, the prompt specifies the length of the description to be generated, for example, fewer than 10 words and/or fewer than 5 words. In some embodiments, the prompt specifies that a single sentence is desired.

In some embodiments, the prompt includes text data representing one or more example descriptors. In such embodiments, the text generator generates the descriptor based on the example descriptors provided in the prompt. In some embodiments, the generated text is dependent on the examples provided. As an example, the generated text may have a length that is controlled by providing examples to the generator.

In accordance with embodiments in which user data and content metadata is used to generate a prompt, an overlap between the content metadata and the metadata of a user profile is determined and the prompt is generated based on the overlap. As an example related to that above, a prompt may be “create a compelling description for this group of content that focusses on the content having similar themes of X, Y, Z that this user has previously enjoyed”. Examples of descriptors include, for example, “Watch More High Octane Thrillers” “Continue your knowledge quest with political documentaries” “Become a Chef extraordinaire with our Cooking collection”.

At step 806, the generated prompt is passed as an input a machine learning derived model. It will be understood that, in the system of FIG. 1, the machine learning model is accessible via a dedicated API and is provided on one or more further computing resources, for example, remote server 54. As part of passing the prompt to the model, the generated prompt is packaged in a request for the model. The request is in a suitable format for the model, for example, in accordance with an API request for the model. Step 806 may include setting values for model parameters for the request. The parameters will depend on the generative model used. For example, the parameters may include, version or subversion of the model desired, maximum number of token for the reply. After creating a request, the request is sent to the remote server.

At step 808, in response to receiving the request, descriptive text in the form of a descriptor is generated by the model on the remote server 54 based on the prompt and returned. Step 808 may include an authentication process with the remote server 54.

At step 810, the descriptive text is transmitting from the remote server to the recommendation system for display, as described with reference to step 710 of FIG. 6.

FIG. 8 depicts a flow-chart for a method of generating a descriptor for a group of content items in accordance with a further embodiment. The steps 902, 904 and 906 substantially correspond to steps 702, 704, 706 of the method of FIG. 6.

At step 907, user data for a user is obtained. In the embodiment of FIG. 8, a feature vector is obtained, for example, generated by the user profile module or from the user profile table 30. The feature vector represents user data for a user. In particular, the feature vector is based on or forms part of a user profile that is determined using content engagement data. The feature vector may be obtained or generated by user profile module 26 or may have been previously generated and stored on hard disk storage.

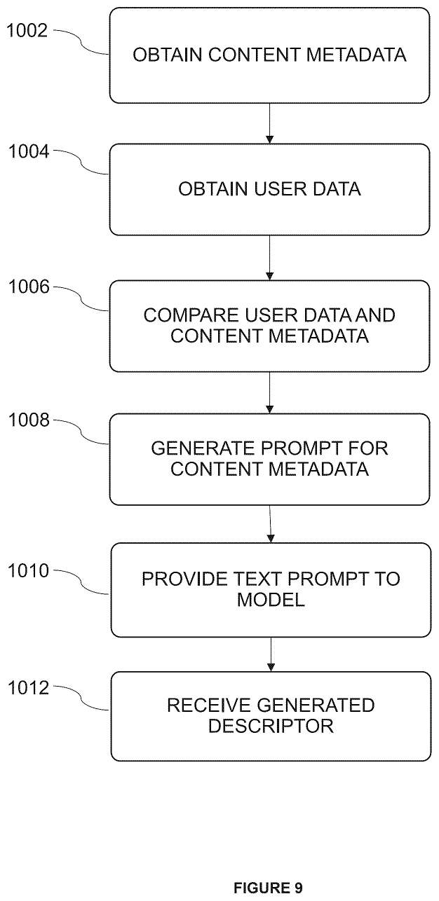

At step 908, a descriptor for the group of items is generated based on the content metadata obtained at step 906 for the group of items and the user data obtained at step 907. Step 908 is described in further detail with reference to FIG. 9.

At step 910, the generated descriptor is displayed on the content selection interface, substantially as described with reference to step 710 of FIG. 6. In some embodiments, the descriptor is stored and is not displayed.

FIG. 9 represents a method of generating a descriptor for a group of items, in accordance with an embodiment. Step 1002 corresponds to step 802 of the method of FIG. 7.

At step 1004, user data for a user is obtained. A feature vector is obtained, for example, generated by the user profile module or from the user profile table 30. The feature vector represents user data for a user. In particular, the feature vector is based on or forms part of a user profile that is determined using content engagement data. The feature vector may be obtained or generated by user profile module 26 or may have been previously generated and stored on hard disk storage.

In embodiments, the feature vector for a user profile is a vector in the same multi-dimensional vector space as the feature vectors for the content items. As such, each content item may be represented by a feature vector in that space, and each user is represented by a feature vector in that space.

At step 1006, a comparison process between the content metadata and the user data is performed. The comparison may include determining the content metadata associated with the content items that is most relevant to the user and selecting and/or filtering the content metadata based on the comparison. The comparison may comprise finding an overlap and/or comment metadata between the content metadata and the user data.

In embodiments, the comparison process includes compare a feature vector of a user with feature vectors of content items. A method of performing such a comparison comprises determining a measure of overlap or common features between such vectors. In some embodiments, a mathematical operation is performed on the feature vectors to determine said overlap. In some embodiments, an inner or dot product or other vector operation is performed and the size of product represents the degree of match or similarity between the user and the content item.

In some embodiments, the content metadata is filtered and in other embodiments the user data is filtered. In some embodiments, a subset of the content metadata representing a customized and/or personalized set of the content metadata for the user is generated.

At step 1008, the prompt generator processes the subset of content metadata and/or filtered feature vector from step 1006 to generate a prompt. The prompt is in a suitable input format for the generative language model. In the present embodiment, the prompt is a text string. As a non-limiting example, the prompt is in a human readable format, and is of the format: “Generate a descriptor for a carousel for content metadata A, B and C” where A, B and C are three content metadata items derived at step 1008. It will be understood that more than three features may be used. In embodiments, the prompt may be based on the comparison process of the preceding step.

At step 1010, the generated prompt is passed as an input to a generative language model, as described with reference to step 806 of FIG. 7. Step 1012 corresponds to step 810 of FIG. 7.

Although a particular system arrangement is shown in FIG. 1, there are various system arrangements that could be used.

FIG. 10 shows a “middleware” arrangement in which the recommendation system 2 sits as “middleware” between the users 205 and systems of a content provider 210. The recommendation system 2 is implemented by processing resource 220 (which may comprise one or more processors) with the storage device 4 and user cache 6. In some examples, the recommendation system 2 can be implemented by a cloud computing system, by one or more servers or other suitable enterprise level computing system. In this arrangement, systems that implement the recommendation system 2 receive data sent from the user devices 40 of the users 205 that represents the user actions/user activity taken by the user 205 that are relevant to the content selection interface, such as but not limited to actions taken by the user 205 during operation of the content selection interface, including one or more of the user actions listed above. The user devices 40 also provide a user ID that can be used to identify the user 205 to allow the provision of a content selection interface that is customized for that user 205. The user devices 40 communicate the data over a network, such as the cloud 215, to the recommendation system 2. The recommendation system 2 records the user actions in order to generate learn actions and build and update a user profile that can be used to configure and customize a content selection interface for the user 205. The recommendation system 2 can communicate the requests and other data from the user devices 40 to the content providers systems 210 in order to provide the content to the user devices 40. Access between recommendation system 2 and the model server 54 is provided via a network such as the cloud 215.

FIG. 11 shows an alternative system configuration in a “backend” processing arrangement. In this arrangement, the user devices 40 interface directly with the systems of a content provider 210, which implements the content selection interface and handles the requests from the user devices 40. User interaction data from the user devices 40 is provided by the systems of a content provider 210 to the recommendation system 2 in order for the recommendation system 2 to identify learn actions and build user profiles for at least partly customizing the content selection interface for that user. The recommendation system 2 provides the data for customizing the content selection interface for that user, including an ordering with which to present at least some of the groups of content in the user selection interface, to the systems of a content provider 210 for providing in the content selection interface for that user 205. The user selection interface may also be referred to as a content selection interface. Access between recommendation system 2 and the model server 54 is provided via a network such as the cloud 215.

The processing resource can optionally comprise one or more processors, FPGAS, ASICS or the like, which may be provided in a single machine or distributed over a plurality of machines, and may be locally arranged or remote from each other and connected over a network. The processing resource 220 is configured to communicate with content databases, such as the EPG module 8, to retrieve content available from the content provider. The processing resource 220 comprises rapid access storage, such as user cache 6, which may be implemented in RAM or SSD storage to provide fast access to user profiles and actions that the processing resource is currently, and will next be, performing operations on. The processing resource is also configured to communicate with external storage such as storage device 4 on which user actions and profiles are stored and can be retrieved into the use cache 6 when needed by the processing resource 220.

The system described herein can be used to provide a content selection method and system that may in some examples allow a user to more quickly identify content of interest and to better navigate content available from a content provider system.

Although various specific examples have been described above, these are provided to help understanding of the present disclosure and other possible implementations can be used. For example, although specific arrangements of systems and networks that could be used to implement the concepts disclosed herein are shown in FIG. 1, FIG. 10 and FIG. 11, other systems architectures could be used. For example, the UX engine 12 could be provided as a stand-alone system rather than being integrated with the content recommendation engine 22 or integrated into a content provider system rather than being provided as a separate intermediate or backend system.

Method steps described herein can be performed by one or more programmable processors executing a computer program to perform functions of the invention by operating on input data and generating output. Method steps can also be performed by special purpose logic circuitry, e.g., an FPGA (field programmable gate array) or an ASIC (application-specific integrated circuit) or other customized circuitry. Processors suitable for the execution of a computer program include CPUs and microprocessors, and any one or more processors. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g. EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the invention can be implemented with a user device 40 having a screen, e.g., a CRT (cathode ray tube), plasma, LED (light emitting diode) or LCD (liquid crystal display) monitor, for displaying information (e.g. the content selection interface 605) to the user and an input device, e.g., a keyboard, touch screen, a mouse, a trackball, and the like by which the user can provide input to the computer. Other kinds of devices can be used, for example, feedback provided to the user can be any form of sensory feedback, e.g., visual feedback, auditory feedback, or tactile feedback; and input from the user can be received in any form, including acoustic, speech, or tactile input.

The above embodiments describes collection of user data. It will be understood that in some embodiments, the system may be configured such to restrict or not allow access to personal information, or data that could be used to determine the name of a user, or demographic information concerning the user.

As such, the above description of specific embodiments is made by way of example only. A skilled person will appreciate that variations of the described embodiments may be made without departing from the scope of the invention.

1. A computer-implemented method for generating text data comprising a descriptor for a group of content of items, the method comprising:
obtaining, from at least a first data source, content metadata associated with a group of content items, wherein the content metadata is represented by at least one feature vector or other mathematical representation;
processing, by a processing resource, the at least one feature vector or other mathematical representation to generate a prompt for a descriptive text generator model;
transmitting, via a model interface, a request over a network to the model server, wherein the request comprises the generated prompt;
generating, by the descriptive text generator model at the model server, a descriptor for the group of content items in response to receiving the request, based on the prompt;
receiving, by the processing resource, the generated descriptor from the model server;
at least one of displaying, by a display, and storing, by a storage resource, the generated descriptor.

2. The method of claim 1, further comprising displaying a content selection interface representing a plurality of content items, wherein the method comprises selecting, by a user, one of the plurality of content items, wherein the method further comprises displaying the generated descriptor as part of the content selection interface.

3. The method of claim 1, the method further comprising:
obtaining user data for a user;
generating the descriptor based on the obtained user data to provide a personalized descriptor for the group of content items.

4. The method of claim 3, comprising performing a comparison between the content metadata and the user data, wherein the comparison may include determining the content metadata associated with the content items that is most relevant to the user and selecting and/or filtering the content metadata based on the comparison.

5. The method of claim 1 further comprising filtering the content metadata, a subset of the content metadata representing a customized and/or personalized set of the content metadata for the user is generated.

6. The method of claim 1 further comprising obtaining user data for a user and content metadata for a content item and wherein generating the prompt for the descriptive text generator is based on the obtained user data and content metadata.

7. (canceled)

8. The method of claim 3, further comprising determining an overlap and/or determining common metadata between the content metadata and the user data and generating the descriptor based on the overlap and/or common metadata.

9. The method of claim 3, further comprising representing the user data as a first feature vector or other mathematical representation and the content metadata as a second feature vector or other mathematical representation, and wherein the descriptor is based on a determination of a dot product or other measure of overlap between the first feature vector or other mathematical representation and the second feature vector or other mathematical representation.

10. The method of claim 1, comprising obtaining metadata associated with each content item in a group of content items and combining the metadata into group metadata for the group.

11. The method of claim 2, wherein the plurality of content items are grouped into two or more groups, each group represented in the content selection interface as part of or associated with an interactive graphical element and wherein the method further comprises generating a descriptor for each group using content metadata for each content item of the group and displaying the interactive graphical element together with the descriptor.

12. The method of claim 2, wherein the content selection interface comprises a plurality of scrollable carousels and the method comprises providing respective at least said group of content to the user in a scrollable carousel of the user interface together with the generated descriptor.

13. The method of claim 1, wherein generating the descriptor further comprises applying a pre-determined generative model or other machine learning or artificial intelligence model to at least the content metadata.

14. The method of claim 1, wherein the generating of the descriptor is performed as part of a content recommendation process.

15. The method of claim 1, wherein the method comprises obtaining a group of candidate items and/or their identifiers, optionally based on user data, as part of a content recommendation process and retrieving metadata for said group of candidate items, as part of the content recommendation process.

16. A system comprising a processing circuitry configured to generate text data comprising a descriptor for a group of content of items, wherein the processing circuitry is configured to:
obtain content metadata, from at least one data source, associated with a group of content items, wherein the content metadata is represented by at least one feature vector or other mathematical representation;
process, by the processing resource, the at least one feature vector or other mathematical representation to generate a prompt for a descriptive text generator model;
transmitting, via a model interface, a request over a network to the model server, wherein the request comprises the generated prompt;
generate a descriptor for the group of content items based on at least the content metadata associated with the group; and
receiving, by the processing resource, the generated descriptor from the model server;
wherein the system comprises at least one of: a display configured to display the generated descriptor and a storage resource for storing the generated descriptor.

17. The system of claim 16 wherein the system comprises the display and the display is configured to display a content selection interface representing a plurality of content items, wherein the content selection interface is operable by a user to select one of the plurality of content items.

18. (canceled)

19. A non-transitory computer-readable medium that comprises computer-readable instructions that, when executed by a processor, cause the processor to:
obtain content metadata, form at least one data source, associated with a group of content items, wherein the content metadata is represented by at least one feature vector or other mathematical representation;
process, by the processing resource, the at least one feature vector or other mathematical representation to generate a prompt for a descriptive text generator model;
transmit, via a model interface, a request over a network to the model server, wherein the request comprises the generated prompt;
generate a descriptor for the group of content items based on at least the content metadata associated with the group;
receiving, by the processing resource, the generated descriptor from the model server; and
at least one of transmit the generated descriptor to a display for display or store the generated descriptor.
